(19) United States
(12) Patent Application Publication
(10) Pub. No.: US 2008/0128668 A1
(43) Pub. Date: Jun. 5, 2008

(54) MULTIPLE LINE POWERED ROPE ASCENDER AND PORTABLE HOIST

(75) Inventors: Timothy Fofonoff, Cambridge, MA (US); Nathan Ball, Boston, MA (US); Daniel Walker, Cambridge, MA (US); Bryan Schmid, Boston, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: Atlas Devices LLC, Cambridge, MA (US)

(21) Appl. No.: 11/937,623

(22) Filed: Nov. 9, 2007

Related U.S. Application Data
(60) Provisional application No. 60/858,775, filed on Nov. 14, 2006.

(51) Int. Cl. B66D 1/36

(52) U.S. Cl. 254/334

(57) ABSTRACT

A multiple-rope or multiple-cable pulling device is provided for positioning a load. The device can include an electronic controller that interprets a user's input from an interface such as a trigger or a joystick, and activates electronically controlled motors that drive one or more rope pulling mechanisms, such as winches. When the winches pull in or pay out cable in accordance with the controller's demand, the load is moved along the desired trajectory as specified by the user through the device interface.

### RELATED APPLICATIONS

This application claims priority to U.S. Provisional Patent Application Ser. No. 60/858,775, entitled Multiple Line Powered Rope Ascender and Portable Hoist, filed on Nov. 14, 2006, which application is hereby incorporated herein by reference.

### FIELD OF INVENTION

This invention relates to devices for moving an object by pulling on two or more tensile elongate elements to which the object is attached. More particularly, the invention relates to a device that attaches to and preferentially pulls on multiple ropes or cables for positioning a load in multidimensional workspaces.

### BACKGROUND OF THE INVENTION

Existing methods of gaining access to large vertical faces such as the sides of buildings or rock faces are limited to either minimal 1-dimensional access capabilities, such as single rope rappelling systems for climbers, rescuers, or window washers, or large, bulky installations such as cranes, scaffolding, or external elevators.

Window washing systems that utilize standard rappelling equipment are limited in their access to the side of a building by the single line from which the operator hangs. In order to move laterally for any significant distance, the operator must descend to the bottom of the building, return to the rooftop and reposition his line, and then re-descend to the desired position. Similarly, climbers and rescue personnel who wish to access a specific point on a rock face or other vertical site must descend from directly above the desired position. When access to the ideal starting position above the target is not available, the operator may face extreme difficulty in accessing the desired position and must resort to additional support personnel or equipment to provide lateral movement capabilities.

For large buildings where it may be appropriate to do so, scaffolding systems can be set up, either stationary or movable, to provide 2 dimensional access to the entire building face where needed. However, any system capable of providing such access requires significant cost, space, setup time, and operation time. Alternatively, ground lift systems such as cranes or vertical hoists can be used, but face similar limitations of cost, space, and access provided.

A device that can be quickly, cheaply, and easily deployed which can give an operator precise, safe, and reliable access to vertical workspaces, such as sides of buildings and rock faces, would be of significant benefit to a variety of users. Rescue personnel could descend from a high point adjacent to the victim, instead of directly from above, and approach them laterally without disturbing loose and potentially dangerous objects, overhead obstacles, or the victim. Window washers could access an entire building face without needing to reset overhead lines, and construction workers could deliver equipment and personnel quickly and easily to many points on a high worksite. Additional functionality could be found in the entertainment industry, running high wires to pull actors into the air and manipulate their position in 2 dimensions remotely without the need for overhead rolling track carrier systems, as well as other setups where such carrier systems are needed. Other uses include installing, positioning and uninstalling overhead speaker and light systems at concerts and sporting events, as well as positioning camera systems.

Similarly, positioning loads in 3 dimensional spaces is commonly accomplished by large, bulky systems such as overhead gantries or cranes that are not designed for portability or low cost. The ability to use a single low-cost device to accurately position loads, including workers, could be significantly advantageous for situations where a load manipulation system must be modular, quickly deployable, or able to fit and maneuver in confined spaces. Still another application where a 2 or 3 dimensional load positioning system would have further advantages over existing load positioning technology such as conventional hoists with swinging booms is in a hospital, where heavy patients must be maneuvered from stretchers to operating tables. Conventional hoists with swinging arms are impractical because the trajectory of the boom and the patient require that the entire area be clear to avoid collisions with equipment.

It is therefore an object of the present invention to provide an apparatus for lifting or pulling heavy loads and controlling their position in 1, 2 or 3 dimensions which solves one or more of the problems associated with the conventional methods and techniques described above.

Another object of the present invention is to position loads vertically by ascending or descending a rope or cable fixed above the load.

Another object of the present invention is to optionally utilize one or more ropes or cables affixed overhead and at a distance from one another in order to facilitate two dimensional or three dimensional positioning of a load, be it a person or an object.

It is also an object of the present invention to be able to manipulate a single rope, so that if multidimensional positioning is not required, the same device can still be utilized for powered ascent and descent in a single dimension.

It would also be desirable to be able to attach any such rope pulling device to a rope at any point along that rope without having to thread an end of the rope or cable through the device. This would increase the usability of such a device considerably over other rope pulling and climbing devices, allowing for example a user to attach the load or himself to the device for ascent that starts at an elevation well above the lower end of the rope.

Other objects and advantages of the present invention will be apparent to one of ordinary skill in the art in light of the ensuing description of the present invention. One or more of these objectives may include:
(a) to provide a line pulling device that can handle a range of rope types, cables, and diameters;
(b) to provide a device that can interface with 1 or more ropes and control each rope independently;
(c) to provide a device which does not require an end of the rope or cable to be fixed to the device;
(d) to provide a device which provides a smooth, controlled, continuous pull;
(e) to provide a device which itself is capable of traveling upward along ropes or cables smoothly and continuously to raise a load or a person;
(f) to provide a device which is easy and intuitive to use by minimally trained or untrained personnel;
(g) to provide a device which can pay out, or descend, ropes or cables at a controlled rate for a range of loads;
(h) to provide a device which can apply its pulling force both at high force levels, for portable winching applications, and at fast rates, for rapid vertical ascents;
(i) to provide a device with a safety lock mechanism that prevents unwanted reverse motion of the rope or cable;
(j) to provide a device that can attach to a rope or cable at any point without having to thread an end of the rope or cable through the device;
(k) to provide a device that is not limited in its source of power to any particular type of rotational motor;
(l) to provide a device that is usable in and useful for recreation, industry, emergency, rescue, manufacturing, military, and any other application relating to or utilizing rope, cable, string, or fiber tension;
(m) to provide a device that can be operated remotely, either via wireless communication, remote wired interface, or other means;
(n) and to provide a device that interprets a user's input and translates it into the desired motion vector of the load through space in 1, 2 or 3 dimensions.

Still further objectives and advantages are to provide a rope or cable pulling device that is as easy to use as a cordless power drill, that can be used in any orientation, that can be easily clipped to a climbing harness, Swiss seat, or other static load suspension equipment, that can be just as easily attached to a grounded object to act as a winch, that is powered by a portable rotational motor, and that is lightweight and easy to manufacture.

While a number of objectives have been provided for illustrative purposes, it should be understood that the invention described below is not limited to any one of the illustrative objectives. It should further be understood that these illustrative objectives are stated in terms of the inventors' view of the state of the art, the objectives themselves are thus not prior art or necessarily known beyond the inventors.

### SUMMARY OF THE INVENTION

The invention provides a multiple-rope or multiple-cable pulling device that preferably accomplishes one or more of the objects of the invention or solves at least one of the problems described above.

In a first aspect, a device of the invention includes an electronic controller that interprets a user's input from an interface such as a trigger or a joystick, and preferentially activates electronically controlled motors that drive one or more rope pulling mechanisms, such as winches. When the winches pull in or pay out cable in accordance with the controller's demand, the load is moved along the desired trajectory as specified by the user through the device interface.

An embodiment of the invention can be incorporated into a convenient portable hand-held motorized device, and in particular, can be configured as a portable hoist. Further aspects of the invention will become clear from the detailed description below, and in particular, from the attached claims.

The present invention can provide a useful solution because at minimum, its operation only requires the space of the straight-line trajectory through which the load and the ropes must move, as opposed to conventional boom hoists which require a larger work volume to accomplish the same movement. Additionally, the installation of the present invention to accomplish multidimensional load movement can be much lower profile and lower impact than that of a conventional hoist, by requiring only either 2 or 3 stationary fixture points for operation.

By utilizing a two-rope device, the operator can position the load or himself anywhere along a vertical plane passing through the two rope connection points by independently and simultaneously controlling and adjusting the lengths of the ropes actively fed through the device during its operation. Note that the load, here, can be an object, a person, or the operator, and that the ropes can be replaced by cables or other tensile elongate elements.

By utilizing a three-rope device, the user can position the load anywhere within a three dimensional space. By adjusting the relative lengths of rope above the device, its position can be controlled to anywhere within the volume of space projected downward from the three rope attachment points. Note again that the load, here, can be an object, a person, or the operator, and that the ropes can be replaced by cables or other tensile elongate elements. For greater load carrying capacity or movement within geometrically constrained spaces, such as a warehouse with tall items obstructing the desired path of the load, a device capable of manipulating 4 or more ropes could be utilized to provide added positional control beyond the capability of a 2 or 3-rope device.

The control of a multiple rope device can be achieved through a variety of configurations. One configuration consists of the device presenting to the operator one interface for each of the ropes passing through the device, be it a trigger, a switch, or a joystick. In this case, the operator manually controls the relative lengths and speeds of the ropes passing through the device, causing the ropes to move in the upwards or downwards directions as needed.

A second configuration consists of the device presenting to the operator an interface, for example a joystick, that allows the operator to input his intended direction for the load, whereby the device computes and automatically adjusts the incoming and outgoing rope lengths and speeds to accomplish the task. In the two rope device case, with the device and operator positioned with one attachment point above and to the left and the other attachment point above and to the right, the operator can input, for example, an up, down, right, or left intended direction on the interface in order to move in that direction. Intended diagonal directions, such as up-left, up-right, down-left, and down-right could also be accepted and delivered by the device. Such a configuration would be very useful for positioning the load within a plane, for example against a wall.

This configuration can be extended to three dimensional positioning within a volume, where again the operator inputs an intended direction and speed, and the device computes and delivers the corresponding three rope feed rates to move the load in the intended direction at the intended speed.

A third configuration consists of the device operator himself acting as the device controller. The operator may manually indicate rope directions and speeds independently of one another by squeezing a single trigger associated with each rope, or by manually activating each respective motor controller by some other means. One such configuration for 2 dimensional movement would comprise 2 triggers, each corresponding to one rope. The operator would pull a trigger to pull in rope, and pull a second trigger or button to release that rope. A parallel setup would correspond to the second rope. By preferentially pulling in and paying out ropes via manual control, the operator can move himself or the load along the desired trajectory. This means of control may also serve useful as a backup in conjunction with any automated controller associated with the device. A person of ordinary skill in the art will note that this manual control setup can be extrapolated to 3 rope, and thus 3 dimensional control, and even additional ropes beyond 3 as a situation may call for.

### BRIEF DESCRIPTION OF THE DRAWINGS

FIG. 1 provides a diagrammatic view of a device of the invention for positioning a load;

FIG. 2 provides a diagrammatic view of the device of FIG. 1 in 2 dimensional use, with definitions of ropes and reference angles for trajectory computation by the device controller;

FIG. 3 provides a diagrammatic view of a further embodiment of a device of the invention for positioning a load;

FIG. 4 provides diagrammatic view of a further embodiment of a device of the invention for positioning a load;

FIG. 5 shows a schematic view of a person operating the device of FIG. 1 in 2 dimensions;

FIG. 6 illustrates an isometric view of a device according to the diagram of FIG. 1 in use with two ropes and an operator as a load;

FIG. 7 provides a front isometric view of the device of FIG. 6;

FIG. 8 provides a rear isometric view of the device of FIG. 6;

FIG. 9 provides a rear isometric view of the device of FIG. 6 with a cover of the device removed;

FIG. 10 provides a side view of the device of FIG. 9 with the cover removed; and

FIG. 11 provides an additional side view of the device of FIG. 9 with the cover removed.

### DETAILED DESCRIPTION

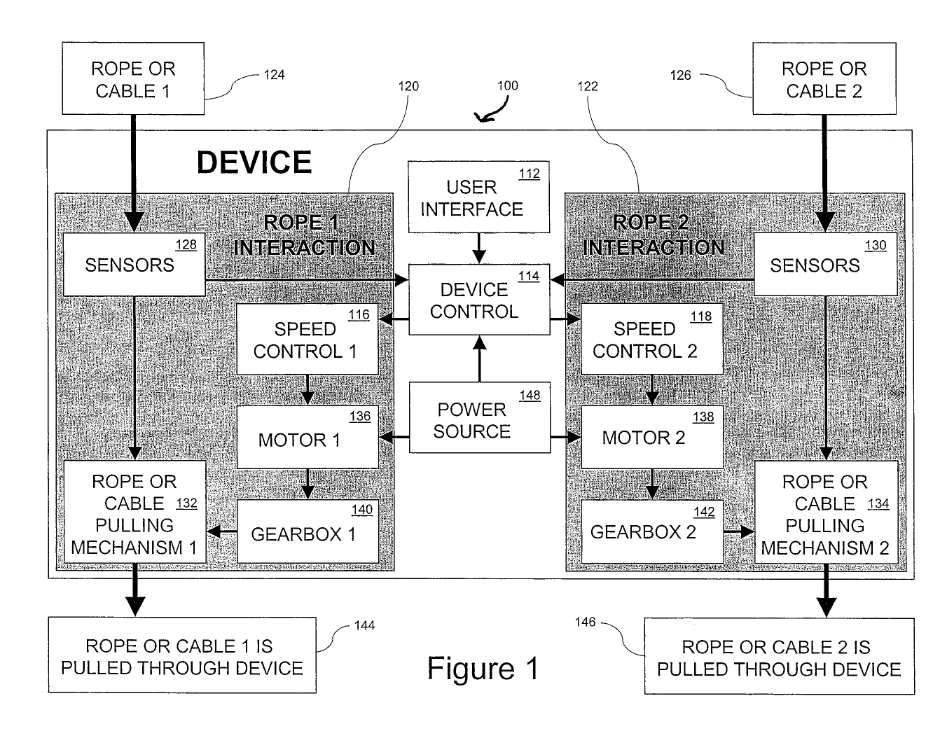

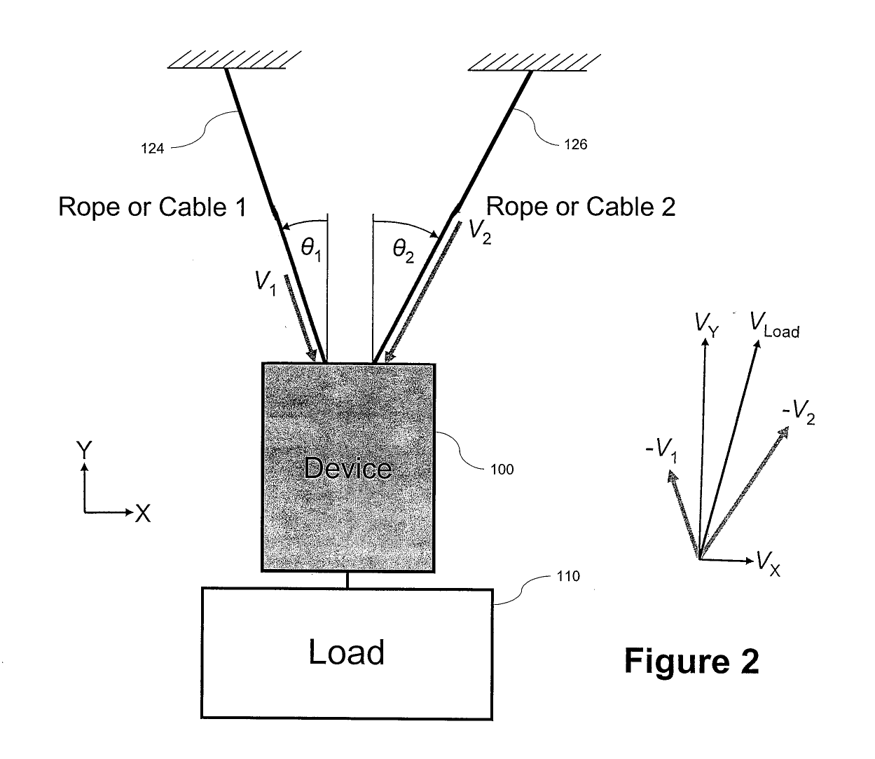

Referring now to FIGS. 1 and 2, a device 100 of the invention for positioning a load 110 in 2 dimensions is illustrated diagrammatically.

A user of device 100 provides an input to the device through the user interface 112 in accordance with the direction he wants to move the load, be it an object, another person, or himself. The device control 114 interprets the command and sends applicable signals to the speed controls 116, 118 in charge of each of the rope interaction mechanisms 120, 122. The signals are such that each of the mechanisms will create a velocity vector V₁, V₂ along its own rope 124, 126, which will sum with the velocity vector of the other rope or ropes to create the desired load trajectory. Sensors 128, 130 detecting the angle θ₁, θ₂ of the ropes with respect to vertical to provide position feedback to the device controller 114, which then updates the necessary speed of each rope feed 132, 134 to maintain the desired trajectory. The equation describing the velocity vectors of each rope as dependent on the respective angles of each rope to vertical is as follows:

$$[ \begin{matrix}{V}_{1} \\ {V}_{2}\end{matrix} ] = [ \begin{matrix}\frac{- cos ( {θ}_{2} ) \cdot {V}_{X} + sin ( {θ}_{2} ) \cdot {V}_{Y}}{- sin ( {θ}_{1} ) \cdot cos ( {θ}_{2} ) + sin ( {θ}_{2} ) \cdot cos ( {θ}_{1} )} \\ \frac{cos ( {θ}_{1} ) \cdot {V}_{X} - sin ( {θ}_{1} ) \cdot {V}_{Y}}{- sin ( {θ}_{1} ) \cdot cos ( {θ}_{2} ) + sin ( {θ}_{2} ) \cdot cos ( {θ}_{1} )}\end{matrix} ]$$

### Equation 1: Rope Velocity Calculation from Rope Angles with Respect to Vertical

Where V₁ is the velocity of the first rope being pulled toward the device, V₂ is the velocity of the second rope being pulled toward the device, θ₁ is the angle that the first rope enters the device, θ₂ is the angle that the second rope enters the device, V_{X} is the component of the intended velocity in the X direction, and V_{Y} is the component of the intended velocity in the Y direction. Note that θ₁ and θ₂ are measured clockwise from vertical at the points where the first rope and second rope enter the device, respectively.

The intended velocity, V_{LOAD}, is inputted by the operator through the user interface 112, via a joystick for example, and is proportional to the degree to which the joystick is pressed by the operator in a given direction. V_{LOAD} is then decomposed into velocity components V_{X} and V_{Y}. At times, V_{X} and V_{Y} can be negative or zero.

FIG. 2 provides a diagrammatic view of a 2 dimensional device 100 and provides a pictographic description of the angles and variables in Equation 1, as described above. A person of ordinary skill in the art will note that the corresponding velocity equation pertaining to 3 dimensional movement must reference 2 angles for each rope in order to fully define the load's position with respect to ground. These angles would be measured by angular sensors positioned on the device and in contact with the ropes, as in the 2 dimensional case. Lastly, because the orientation of the device 100 may change with respect to ground, it is highly advantageous to include a tilt sensor, accelerometer, or other means of detecting the device's orientation in space, in order to correct for any off-axis positioning of the device itself that may occur during movement.

While closed loop feedback control could be used with this embodiment of the invention, it is not required for operation of device 100. With each side of the device under manual control, for example, offering a proportional speed trigger for each rope interaction as the user interface, a user could still achieve satisfactory 2 or 3 dimensional positioning capability by controlling each vector separately.

Once the device controller 114 determines the requisite motor speeds to accomplish the desired trajectory, it sends velocity signals to the respective speed controllers 116, 118, which then activate the motors 136, 138, and optionally gearboxes 140, 142, accordingly. The motors 136, 138 and gearboxes 140, 142 then provide rotational power to the rope pulling mechanisms 132, 134, which pull the ropes through the device 144, 146. A person skilled in the art will note that it is easy to enable remote operation of the device by separating the user input physically from the invention itself. User input would then be relayed to the device either through a remote cable, a wireless communication device, or other remote means.

In a preferred embodiment of the invention, DC motors are utilized for their high power and low weight, though a person skilled in the art will note that the functionality of the device can be enabled by any powered rotational motor, or other power delivery mechanism. An exemplary power source 148 for powering the motors, as well as the device controller, could be a battery, especially a rechargeable batter such as a lithium ion battery.

A rope pulling mechanism is referenced in FIG. 1. The device of the present invention can function with this rope pulling mechanism comprising any one of a variety of existing mechanisms designed to pull in and pay out ropes, cables, or other tensile elongate elements under load, including but not limited to: conventional cable winches, capstan winches, self-tailing winches or mechanisms, grooved or splined pulleys, and other friction drives. In a preferred embodiment, the mechanisms for pulling ropes or other elongate tensile elements are constructed using the principles of published PCT application no. WO 2006/113844 entitled “Powered Rope Ascender and Portable Rope Pulling Device,” which application is incorporated herein by reference. In one embodiment, the devices of WO 2006/113844 could be used as the rope interaction devices 120, 122 of unit 100.

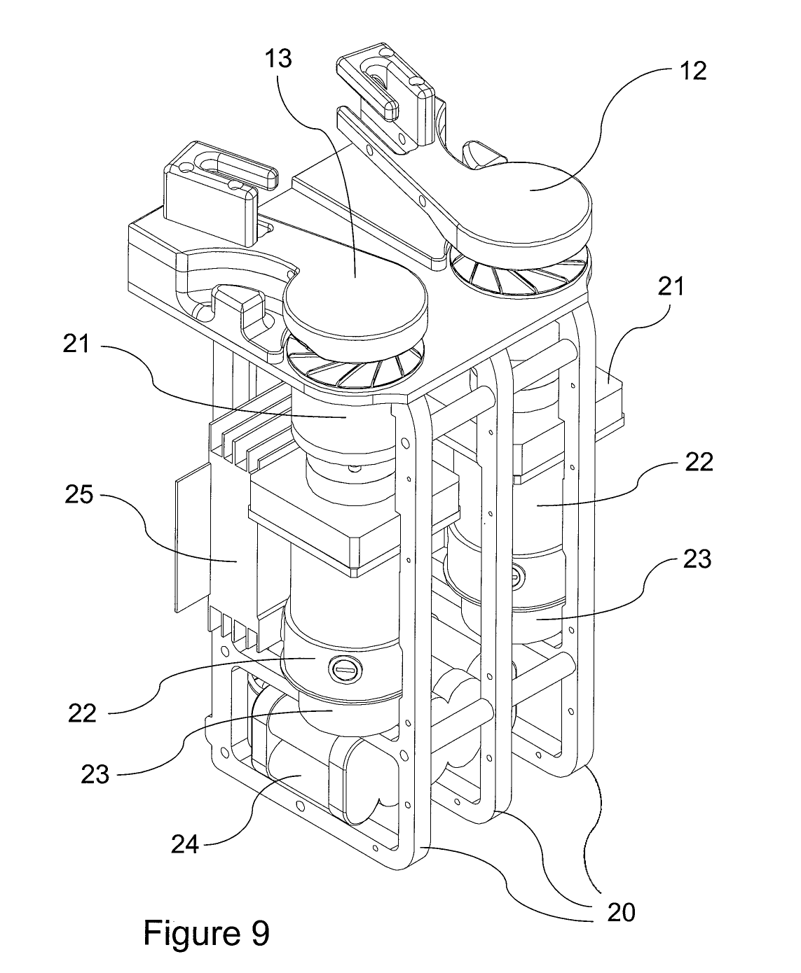

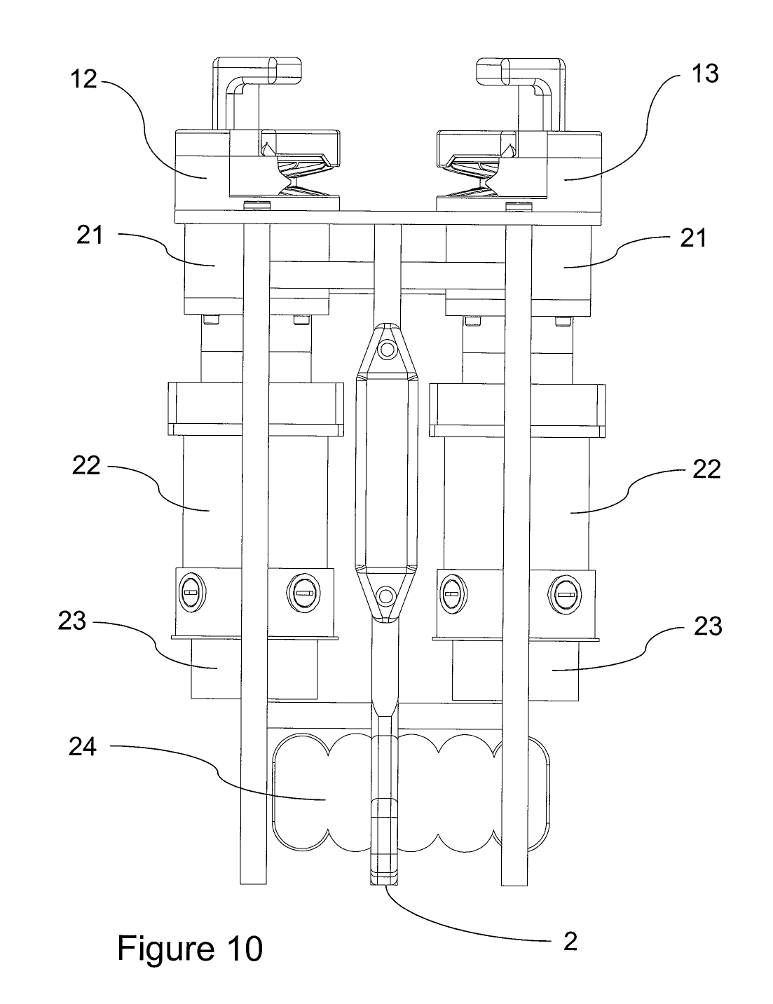

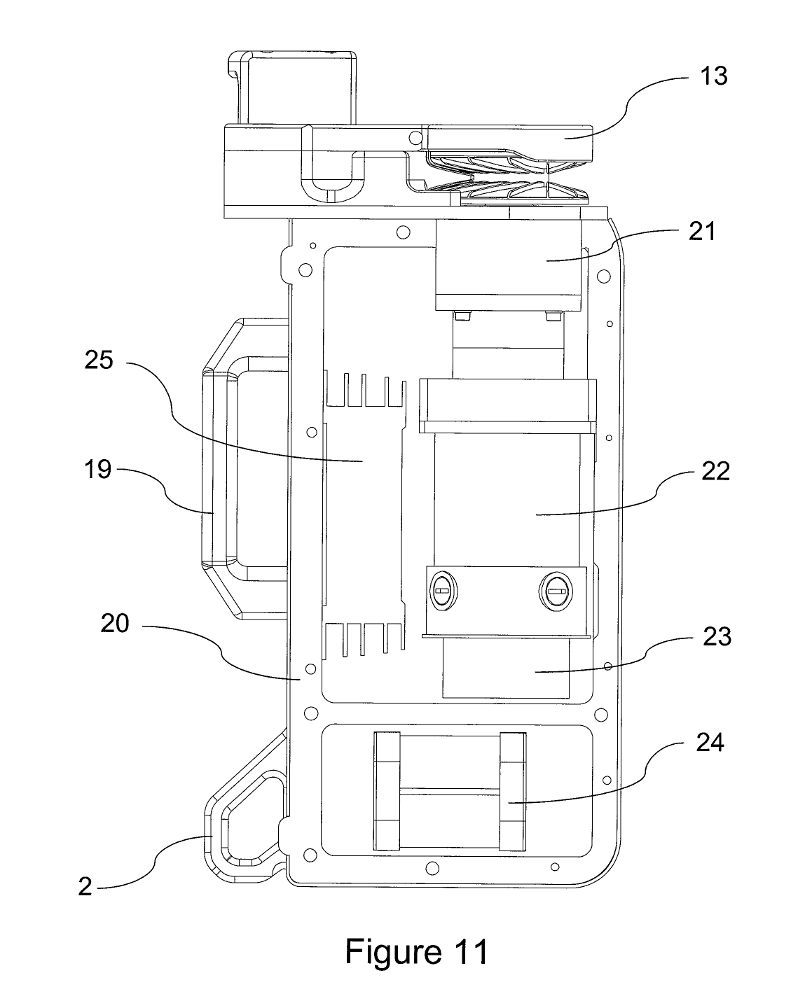

In one embodiment, the rope pulling mechanisms comprise a rotating drum that is connected to the motor, either directly or through a gearbox (if one is present). It is the rotating drum, generally in the manner of a capstan, that applies the pulling force to the rope that is pulled through the device 100. In one embodiment, the rotating drum provides anisotropic friction gripping of the rope. In particular, the surface of the rotating drum can be treated or configured so that large friction forces are created in the general direction of the pulling of the rope (substantially around the circumference of the drum), and smaller friction forces are created longitudinally along the drum so that the rope can slide along the length of the drum, particularly when guided in such a manner by a rope guide, with relative ease. In other configurations, including when the rope runs over the drum for less than one full revolution of the drum, vanes on the drum can guide the rope to the center of the drum where those or other vanes help to grip the rope for pulling by the rotating drum. Such vaned drums are illustrated in FIGS. 9 to 11 below along with exemplary rope guides for guiding the rope onto and off of the rotating drum.

The rope pulling mechanism, any associated rope guide, or the device 100 itself or one of its elements, may also include a brake for holding the rope or ropes. The brake may be manual actuated, electrically actuated upon a signal from the device controller 114, and/or may operate continuously in a one way or ratchet mode in which the rope may be pulled through the device in a direction that allows the load to be lifted, but grabs or brakes movement of the rope if the device begins to slip down the rope or ropes.

In the illustrated embodiment, the rope pulling mechanisms 132, 134 and control elements 114, 116, 118 are integrated into a single unit 100. This embodiment can provide advantages when the operator is the “load” 110. That is, a single integrated unit 100 for lifting or moving the operator is advantageous in that the operator can use the user interface 112 to operate the device while the operator is being lifted or moved. In other embodiments, the user interface 112, for example, could be separated from the device 100 so that an operator could operate the device 100 remotely to lift or move a load 110 other than the operator. Similarly, the rope interaction mechanisms 120, 122 could be separated and not provided in an integral unit 100. Such an embodiment might be useful under certain circumstances to provide orientational stability for a large load—for example, a large rectangular load might have four rope pulling mechanisms, one on each top corner of the load, with all of the rope interaction mechanisms communicating with a common user interface 112 and controller 114. In such an embodiment, each rope interaction device 120, 122 could be provided with its own power source 148.

A rope or cable 124, 126 is also referenced in FIG. 1. The device of the present invention is intended to be able to pull any elongate resilient element that can withstand a tension. Cables and ropes are the most common of these, but the invention is not meant to be limited by the reference to ropes or cables.

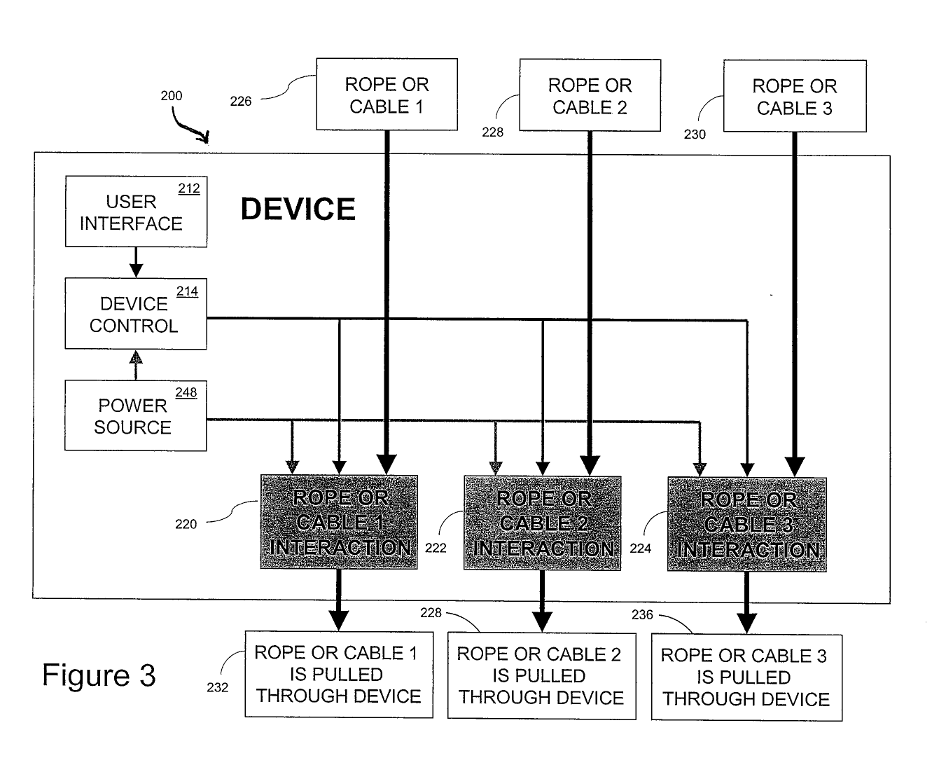

A further embodiment of a device for positioning a load 200 is illustrated by reference to FIG. 3. This device 200 is set up for 3 dimensional positioning of a load or operator within a volume. The relationship between the user input 212, device controller 214, and rope interaction mechanisms 220, 222 is the same as in the embodiment of FIG. 1, but this embodiment includes an additional rope interaction mechanism 224 in parallel with the first two, enabling a third dimension of load positioning by pulling three ropes 226, 228, 230 through the rope interaction mechanisms illustrated as 232, 234, 236. A power source 248 can also be provided for all of the device controller and the rope interaction mechanisms, or separate power sources can be provided. A person of ordinary skill in the art will note that where it may be applicable, additional rope interaction mechanisms may be added in parallel with the first three to enable more precise movement where needed, such as movement around obstacles in a warehouse, or when overhead attachment points for load suspension limit the capability of a three rope device.

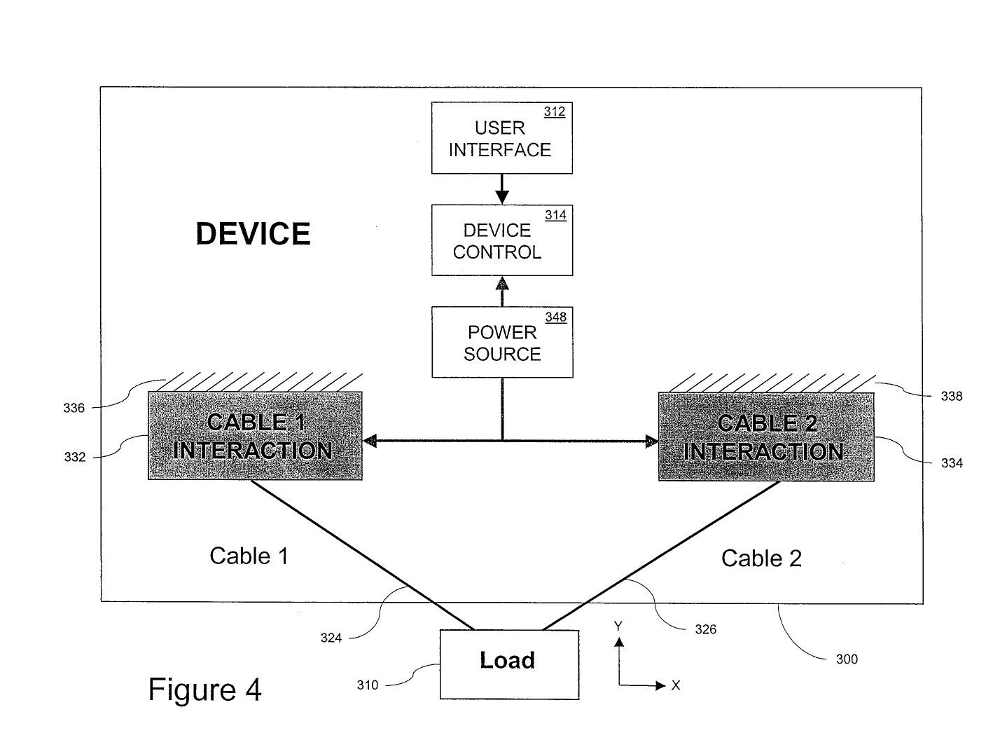

In a further embodiment of the invention, as shown in FIG. 4, the device 300 may be split into separate segments, with each rope interaction mechanism 332, 334 located at the overhead fixture point 336, 338 of each rope or cable 324, 326. The load 310 is suspended between the fixture points by the ropes or cables. To achieve multidimensional load positioning, the fixture points of the rope handling mechanisms must be placed some distance apart. Sensors on the device, in contact with the ropes, indicate the rope angle with respect to a fixed axis to provide position feedback to the device controller 314, as in the embodiment of FIG. 1. The user inputs through user interface 312 his desired trajectory into the device controller 314, which either remotely or directly sends velocity signals to each of the overhead rope pulling mechanisms. As the rope pulling mechanisms appropriately pull in or pay out rope, the suspended load is moved along the desired trajectory. This embodiment may be suitable for more permanent installations, or situations where having the load positioning device travel along with the load is unfeasible. A power source 348 in this embodiment could be centrally located for connection to the cable interaction mechanisms 332, 334 and controller 314, or, each device could have its own power source. Especially in the latter case, the user interface and controller could be provided, for example, by a personal computer, or a handheld digital device such as a PDA.

In another embodiment, the device may be fixed with respect to ground, and the ropes or cables are guided to the load via pulleys located on ceilings, walls, or other fixture points. In cases such as this, where the cable position with respect to the device would not change as a function of load position due to both the device and the first pulleys being fixed with respect to ground, the angular position feedback sensors would need to be located either at the load attachment point or at the last pulley before the load, where the angles of the ropes with respect to a fixed reference such as horizontal or vertical would change as a function of the load's position.

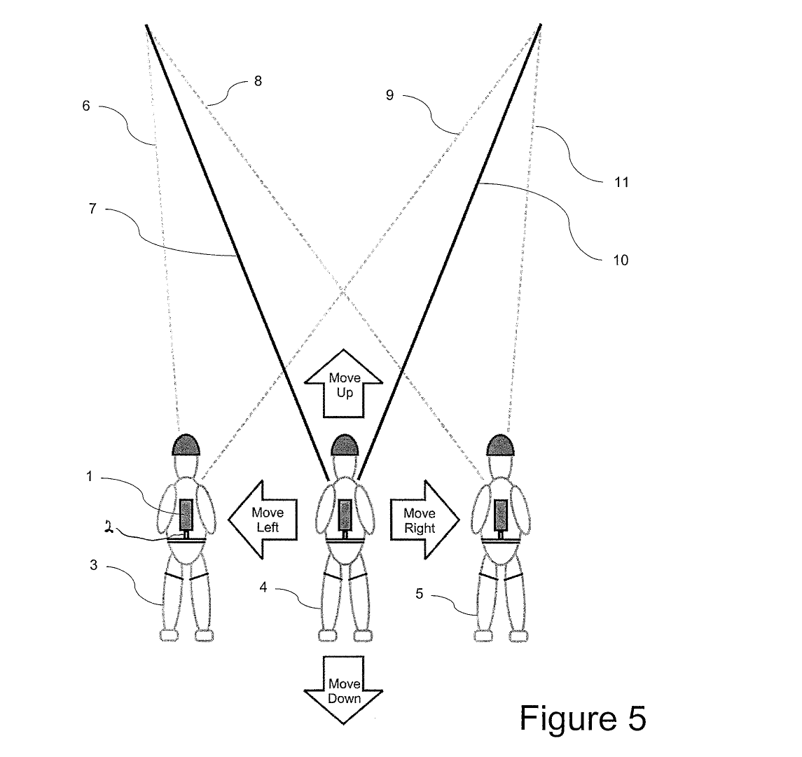

FIG. 5 shows a schematic view of an operator moving in 2 dimensions using the device of FIG. 1. The device 1 is attached to a point on the load, or the harness on the operator in this case, via the clip-in point 2. Upon the operator's input to the device 1 to move left, the left rope in neutral position 7 is pulled into the device 1, and the right rope in neutral position 10 is paid out of the device 1, and the operator advances toward the left position 3. After the operator has reached the desired left position 3, the left rope has been advanced to its left position 6 and the right rope has also been moved to its left position 9. Upon the operator's input to the device 1 to move toward the right, the left rope 6 is now paid out of the device, and the right rope 9 is pulled into the device, thereby translating the operator toward the right position 5. At this final point, the right rope is now in its right position 11, and the left rope is also in its right position 8, and the operator 5 is suspended in his desired place.

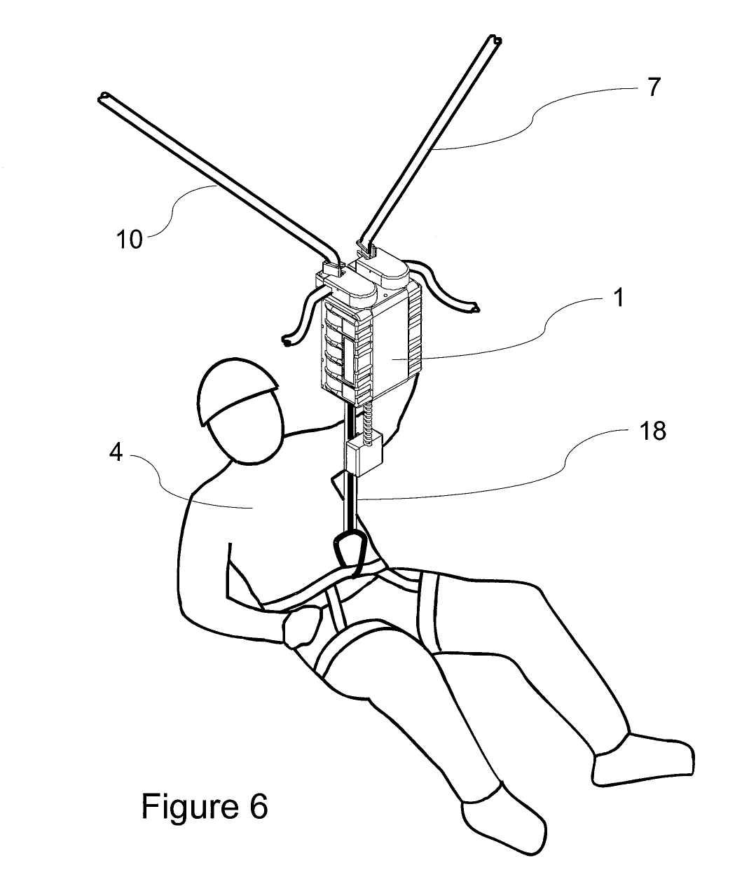

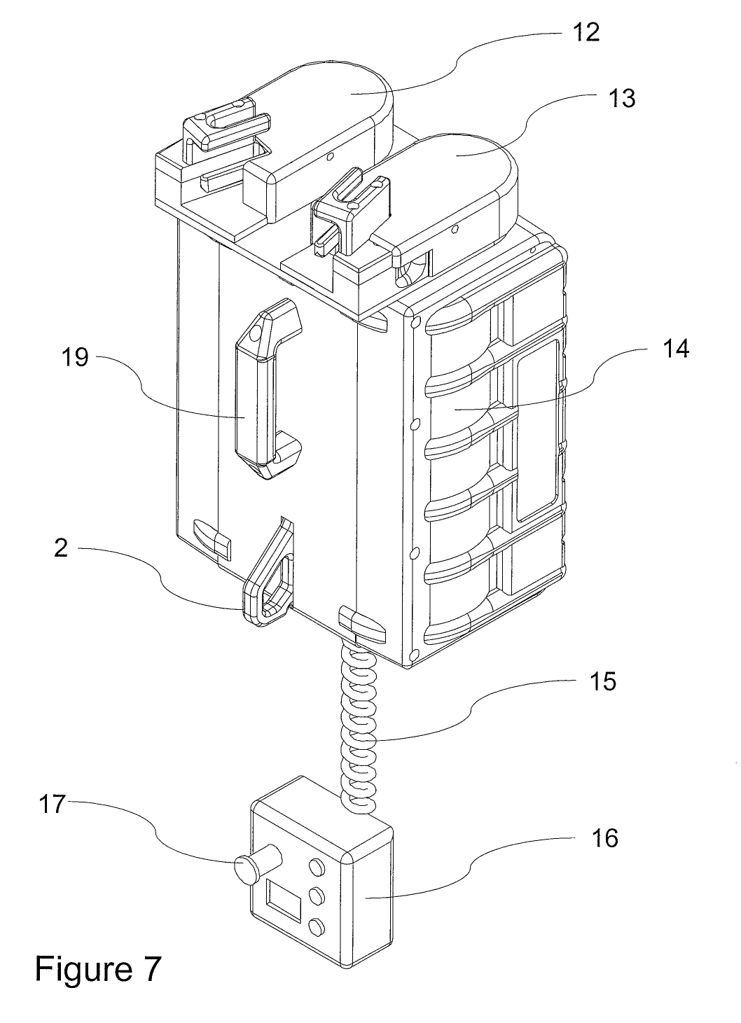

FIG. 6 depicts a three-dimensional view of the device operator 4, hanging in neutral position from a preferred embodiment of the device 1. The operator 4 is tethered to the device's clip-in point 2 via a tensile lanyard 18, both of which are visible in FIG. 7, as well as other Figures. The device is high enough above the operator that he can utilize the device for positioning without the device obstructing his work envelope. As depicted in FIG. 5, the left rope 7 goes into the left rope interaction 12, and the right rope 10 goes into the right rope interaction 13. Control is achieved by adjusting the joystick 17 on the control box 16, which is attached by a short coiled remote cable 15 to the device 1. This allows the device to remain overhead and out of the way, while still allowing easy controllability for the operator.

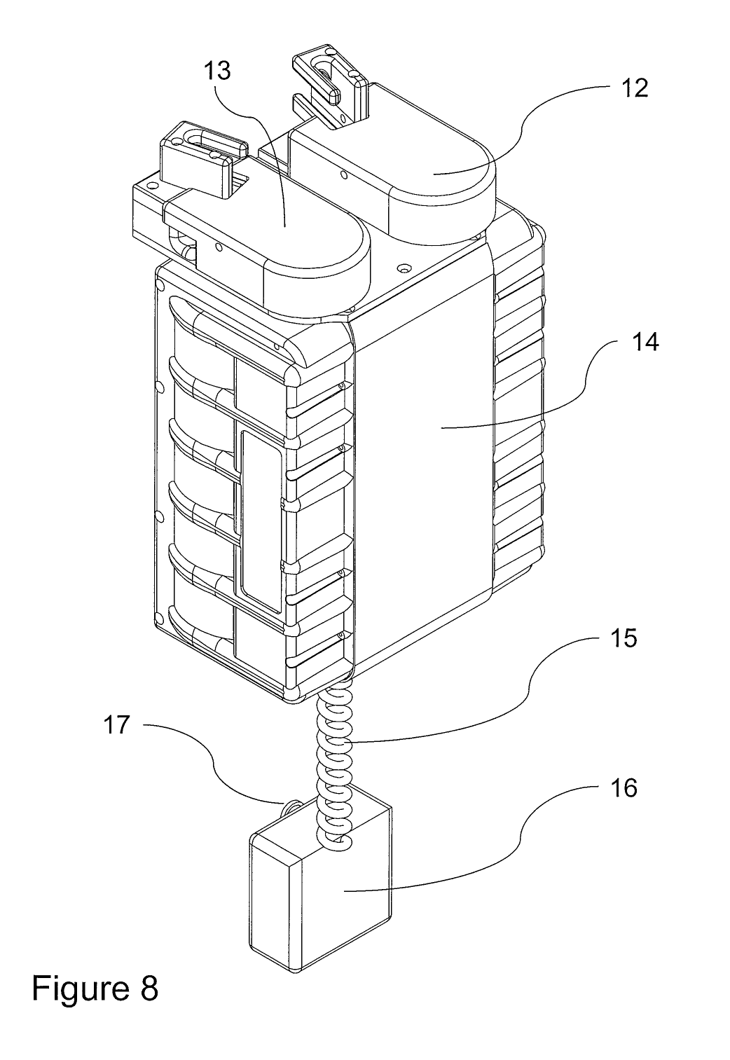

FIGS. 7 and 8 show an embodiment of the invention. The ropes enter the left rope interaction 12 and right rope interaction 13, and exit each respective pulling mechanism on each side. A plastic housing 14 covers the chassis and internal components of the device for ruggedness and safety. A coiled remote cable 15 brings electrical signals back and forth from the control box 16 into the device, and the joystick 17 shown on the control box 16 is a preferred method of control for 2 or 3 dimensions. The operator attaches himself to the clip-in point 2 via some tensile lanyard 18, which may be long enough to hang the operator well below the device such that his work envelope is not obstructed by the device. A carrying handle 19 offers easy transport to and from a work or rescue site.

FIGS. 9, 10 and 11 depict an embodiment of the invention without the plastic housings 14 installed. The left and right rope interactions 12 and 13 are shown without their safety covers, and all underlying components are exposed for viewing. The battery pack 24 supplies electrical power to the motor controller 25, which may contain two or three separate channels, depending on the number of separate rope interactions in the device. One channel is required for each interaction. In this case, a dual channel controller is utilized. The motor controller 25 preferentially applies power to one motor 22 or the other so as to move the load along the desired trajectory. Referring to the left side only for the purpose of this description, the motor 22 applies a rotational torque at a velocity to the backside of the gearbox 21, which then applies a different torque at a different velocity into the left rope interaction 12. Operation is identical for the right side, but with the motor, gearbox, and rope interaction pertaining to that side. The chassis structure 20 holds the components together and provides the tensile elements from which the load hangs.

For safety, an electromechanical safety brake 23 is attached to the back of each motor 22. Such a safety brake requires electrical power to disengage. Before applying power to the motor 22, the motor controller 25 must apply power to the safety brake 23 to release its grip on the back end of the motor shaft. Upon release, the motor 22 can rotate and power the rope interaction to which it is attached. When in the unpowered locked position, the brakes provide a mechanical lock to the rope interaction mechanisms that prevents unwanted motion of the device and load. Thus, even upon power failure, the device and load will remain safely held in place. A person skilled in the art will note that such a brake could be installed on either end of either the motor or gearbox to achieve this safety functionality. Additionally, any suitable power-off brake, whether pneumatically, mechanically, or otherwise released, can provide the same safety functionality as described.

The illustrated embodiments can utilize a high-power DC electric motor, as built by Magmotor Corporation of Worcester, Mass. (part number S28-BP400X, for example) which possesses an extremely high power-to weight ratio (over 8.6 HP developed in a motor weighing 7 lbs). The power source can include batteries such as 24V, 3 AH Panasonic EY9210 B Ni-MH rechargeable batteries. The device incorporates a pulse-width modulating speed control, adjusted by the device controller, that proportionally changes the speed of the motor. The controller can be implemented on a variety of digital microprocessor devices with instructions and calculations coded in software, firmware, or the like.

A person of ordinary skill in the art will recognize that a variety of sensors will suffice to provide positional feedback to the device controller. In the preferred embodiment, angular sensors located on the device indicate the rope's angle with respect to a fixed reference, such as horizontal or vertical. In the alternative embodiment, the angular sensors can be located on the overhead rope pulling mechanisms or at the load attachment point. Other examples of sensors that could work include but are not limited to: rotary encoders on the motors or the outputs of the rope pulling mechanisms, linear or rotary sensors in contact with the rope, optical sensors on the device detecting the length of rope pulled through, and accelerometers on the device that provide inertial position, velocity or acceleration feedback.

A person of ordinary skill in the art will also recognize that the configurations described above are not the only configurations that can employ the principles of the invention. The system and method described above, utilizing multiple rope or cable pulling mechanisms to position loads in 2 and 3 dimensions, can be practically employed in other configurations. While certain features and aspects of the illustrated embodiments provide significant advantages in achieving one or more of the objects of the invention and/or solving one or more of the problems noted in conventional devices, any configuration or placement of all the parts, user interface, device controller, speed controller, power source, gearbox, sensors, and rope pulling mechanisms with relation to one another or to ground could be deployed by a person of ordinary skill in keeping with the principles of the invention.

1. A device for positioning a load suspended by cables, comprising:
a plurality of powered rotational motors having outputs;
a plurality of cable pulling mechanisms, each coupled to its own powered rotational motor output;
a user interface that allows a user to control said device in order to move the load along a desired trajectory in at least 2 dimensions;
whereby when the user controls the device via the user interface, the powered rotational motors activate the cable pulling mechanisms, which then pull in or pay out the cables by which the load is suspended, thereby moving the load along the desired trajectory.

2. The device of claim 1, further comprising a means for powering the rotational motor.

3. The device of claim 2, wherein the means for powering the rotational motor includes a plurality of rechargeable batteries.

4. The device of claim 1, further comprising a means for interpreting the user input and computing requisite cable feed velocities to accomplish the desired movement

5. The device of claim 1, wherein the powered rotational motors are DC electric motors

6. The device of claim 1, wherein each of the cable pulling mechanisms are connected to the outputs of their rotational motors by a gearbox.

7. The device of claim 1, wherein the guide mechanism includes one or more clip elements and is configured to attach to the resilient elongate element without threading an end of the resilient elongate element through the device.

8. The device of claim 1, further comprising a resilient elongate element engaged with the guide mechanism and the rope pulling mechanism.

9. The device of claim 8, further comprising an object having a weight attached to either the resilient element or the device for movement of the object by pulling on the resilient elongate element by the device.

10. The device of claim 9, wherein the object is a person and the person is attached to the device.

11. The device of claim 1, wherein the device is configured to be a portable hand-held device.

12. The device of claim 1, wherein the device is configured to be a multi-dimensional hoist.
